(19) United States
(12) Patent Application Publication
(10) Pub. No.: US 2014/0044167 A1
(43) Pub. Date: Feb. 13, 2014

(54) VIDEO ENCODING APPARATUS AND METHOD USING RATE DISTORTION OPTIMIZATION

(71) Applicant: ELECTRONICS AND TELECOMMUNICATIONS RESEARCH INSTITUTE, Daejeon (KR)

(72) Inventors: Soonheung JUNG, Daejeon (KR); Dong-San JUN, Daejeon (KR); Younhee KIM, Daejeon (KR); Jin Soo CHOI, Daejeon (KR); Jin Woong KIM, Daejeon (KR)

(73) Assignee: Electronics and Telecommunications Research Institute, Daejeon (KR)

(21) Appl. No.: 13/854,499

(22) Filed: Apr. 1, 2013

(30) Foreign Application Priority Data
Aug. 10, 2012 (KR) 10-2012-0088018

(51) Int. Cl. H04N 7/26

(52) U.S. Cl. CPC H04N 19/00896
USPC 375/240.12

(57) ABSTRACT

An apparatus for video encoding includes an image prediction unit configured to generate a prediction image about an input image; and a differential signal generation unit configured to generate a differential signal by subtracting the prediction image from the input image. Further, the apparatus includes a restoration image generation unit configured to generate a first restoration image about the input image using the prediction image; and an in-loop filter unit configured to produce a second restoration image that in-loop filtering has been performed, and after performing rate distortion optimization (RDO) by producing bit amount information necessary for restoring the second restoration image, provide result information of the RDO with the image prediction unit.

### CROSS-REFERENCE TO RELATED APPLICATION(S)

The present invention claims priority of Korean Patent Application No. 10-2012-0088018, filed on Aug. 10, 2012, which is incorporated herein by reference.

### FIELD OF THE INVENTION

The present invention relates to a video encoding apparatus; and particularly, in video encoding by using RDO(Rate Distortion Optimization), to a video encoding apparatus and method using rate distortion optimization, which is capable of obtaining a more accurate optimal encoding mode by using the rate distortion optimization not in a previous step of an in-loop filter but in a image output from an in-loop filter, and reducing the bit amount necessary for restoring differences between a restored image which is finally decoded and an original image to improve the efficiency of the video encoding.

### BACKGROUND OF THE INVENTION

Recently, an adaptive loop filtering method is proposed in the process of video encoding standardization. The adaptive in-loop filtering method reduces errors between an original image and a restored image which is filtered, and improves encoding performance by applying the Wiener filter to a restored image in an encoder.

At this time, the adaptive in-loop filtering method implements an in-loop filter on the basis of the Wiener filter before the restored image is stored in a decoded picture buffer (DPB), and applies filters to the restored image. Further, the adaptive in-loop filtering method includes filter coefficient information used in filtering the restored image in a bit stream to encode same, thus enabling the same filter to be used in a decoder. Furthermore, in order to reduce errors between the original image and the restored image which is filtered, one or more of a Deblocking filter and a Sample Adapt offset (SAO) may be used in the adaptive in-loop filtering method.

The video encoding in a video encoder as descried above is encoded by one of the intra prediction mode and inter prediction mode according to the characteristics of a basic unit which is encoded. Each encoding mode may also have various encoding modes according to a division mode of the basic unit which is encoded, a mode about the direction to refer in the intra prediction, and a mode about a picture to refer in the inter prediction. At this time, the rate distortion optimization (RDO) method is used for obtaining an encoding mode to apply finally. The RDO method is performed by using the difference value between an original image and a restored image, and the bit amount necessary for reconstructing an image. The Equation 1 below shows these relations.

J=D+λR [Equation 1]

The ‘D’ (distortion) is a value indicating a difference between an original image and a restored image, and the value of SSE (Sum of Square Error) is generally used to represent ‘D’. The R(Rate) represents a bit amount necessary for reconstructing an image, and a practically necessary value or a value predicting necessary bit amount is used to represent ‘R’.

The λ is a value representing relation between the rate and the distortion, and is a constant necessary for predicting how much value does ‘D’ have when R is converted into D. Further, λ is obtained by using QP (Quantization Parameter) and various encoding information. Finally, the encoding mode having the minimum J (Cost) value among those obtained through various encoding modes is chosen.

However, there is a problem in that use of the RDO in the previous step of an in-loop filter causes a difference in the restored image which is finally decoded and the necessary bit amount, thereby decreasing the efficiency of the video encoding.

### SUMMARY OF THE INVENTION

In view of the above, the present invention provides, in video encoding by using rate distortion optimization, a video encoding apparatus and method using an RDO, which is capable of obtaining a more accurate optimal encoding mode by using the RDO not in the previous step of the in-loop filter but in the RDO for a image output from the in-loop filter, and improving the efficiency of the video encoding by reducing the bit amount necessary for restoring differences between the restored image which is finally decoded and the original image.

In accordance with a first aspect of the present invention, there is provided an apparatus for video encoding, including: an image prediction unit configured to generate a prediction image about an input image which is a target of encoding using a reference image; a differential signal generation unit configured to generate a differential signal by subtracting the prediction image from the input image generated by the image prediction unit; a restoration image generation unit configured to generate a first restoration image about the input image using the prediction image; and an in-loop filter unit configured to produce, by performing an in-loop filtering for the first restoration image, a second restoration image that in-loop filtering has been performed, and after performing rate distortion optimization (RDO) by producing bit amount information necessary for restoring the second restoration image, provide result information of the RDO with the image prediction unit.

Further, the image prediction unit may determine an encoding mode which is applied to the prediction image using the result information of the RDO.

Further, the bit amount information may be information for restoring difference between the input image and the second restoration image.

In accordance with a second aspect of the present invention, there is provided a method for video encoding, including: generating a prediction image about an input image which is an encoding target using a reference image; generating a differential signal by subtracting the prediction image generated by an image prediction unit from the input image; generating a first restoration image about the input image using the prediction image; producing a second restoration image that an in-loop filtering has been performed, by performing in-loop filtering for the first restoration image; producing bit amount information necessary for restoring the second restoration image; performing rate distortion optimization (RDO) by using the second restoration image that the in-loop filtering has been performed and the bit amount information; determining an encoding mode which is applied to image prediction using result information of the RDO.

Further, the bit amount information may be information for restoring difference between the input image and the second restoration image.

In accordance with an embodiment of the present invention, it is possible to obtain more accurate encoding mode by using the RDO not in the previous step of the in-loop filter but in the image output from the in-loop filter, and it is possible to improve the efficiency of the video encoding by reducing the bit amount necessary for restoring differences between the restored image which is finally decoded and the original image. Further, it is possible to improve the efficiency of the video encoding by performing the RDO using the bit amount information and distortion between the image output from the in-loop filter and the original image.

### BRIEF DESCRIPTION OF THE DRAWINGS

The objects and features of the present invention will become apparent from the following description of embodiments given in conjunction with the accompanying drawings, in which:

FIG. 1 is a detailed block diagram showing a video encoder for rate distortion optimization (RDO) in accordance with an embodiment of the present invention; and

FIG. 2 is a flow chart showing signal processing in a video encoder for the RDO in accordance with the embodiment of the present invention;

### DETAILED DESCRIPTION OF THE EMBODIMENTS

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, embodiments of the present invention will be described in detail with reference to the accompanying drawings which form a part hereof.

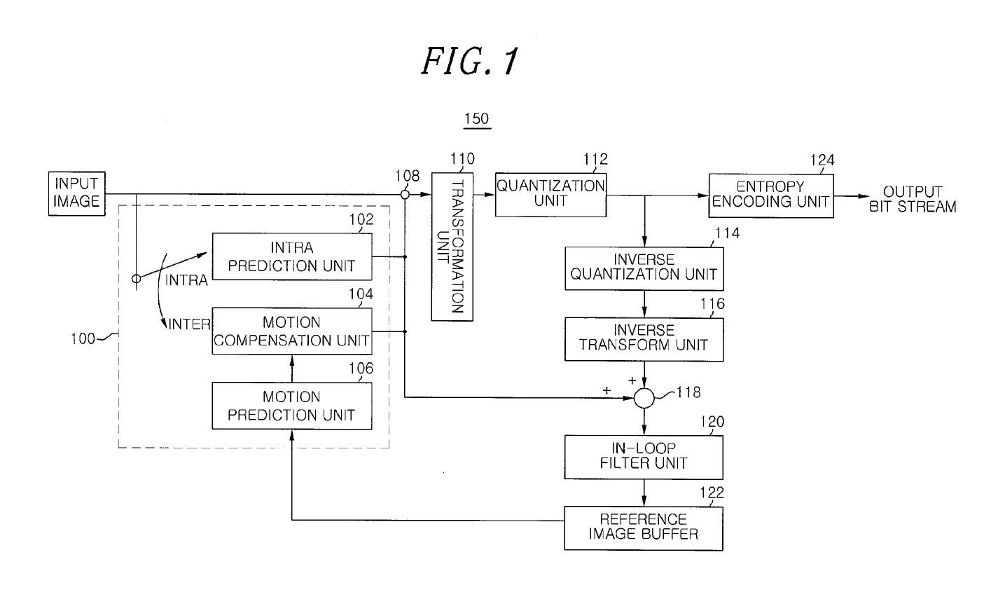

FIG. 1 is a detailed block diagram showing the detailed circuit configuration of a video encoder using rate distortion optimization (RDO) in accordance with an embodiment of the present invention.

As shown in FIG. 1, a video encoding apparatus 150 may include an image prediction unit 100, a differential signal generation unit 108, a transformation unit 110, a quantization unit 112, an entropy encoding unit 124, an inverse quantization unit 114, an inverse transformation unit 116, a restored image generation unit 118, an in-loop filter unit 120 and the like.

The image prediction unit 100 may generate a prediction image about an original input image which is a target of current encoding using a reference image. At this time, the reference image means an in-loop filtered image output from the in-loop filter unit 120.

As shown in FIG. 1, the image prediction unit 100 may include a motion prediction unit 106, an intra prediction unit 102, and a motion compensation unit 104. The motion prediction unit 106 may predict a motion by calculating a motion vector of the motion of an original input image from a reference image, and the motion compensation unit 104 may generate a prediction image by using the motion vector calculated from the motion prediction unit 106.

The intra prediction unit 102 may perform intra prediction in case of generating a prediction image by a intra mode.

The differential signal generation unit 108 may generate a differential signal by subtracting the prediction image generated by the image prediction unit 100 from the input image. That is, when encoding an image block from the input image, the image prediction unit 100 may generate a prediction image block about an encoding target image block. Further, the differential signal generation unit 108 may generate a differential signal about the encoding target image block.

The transformation unit 110 may perform transformation such as a discrete cosine transform on a differential image generated by differentiating the input image and a prediction image to output a transform coefficient. The quantization unit 112 may output a quantization coefficient by quantizing the input transform coefficient according to a quantization parameter.

The entropy encoding unit 124 may generate an output bit stream by entropy encoding of the quantization coefficient and motion vector and the like generated by the transformation unit 110 and quantization unit 112.

The inverse quantization unit 114 may perform inverse quantization of a signal output from the quantization unit 112. The inverse transformation unit 116 may perform an inverse discrete cosine transform or an inverse discrete sine transform about the signal output from the inverse quantization unit 114. The restoration image generation unit 118 may generate a restoration image about an original input image by using the signal output from the inverse transformation unit 116 and a prediction image.

The in-loop filter 120 may be a device processing data for reducing differences between a restored image generated as described above and an original image, and may include SAO, ALF or a deblocking filter and the like. That is, the in-loop filter unit 120 may reduce differences between the restored image and the original input image by combining one or at least two components of SAO, ALF or a deblocking filter, and performing filtering actions for a restored image.

Further, the in-loop filter unit 120 may produce, by performing in-loop filtering for the restored image, a restored image that in-loop filtering is performed, and may produce bit amount information necessary for restoring a restoration image which is in-loop filtered. Subsequently, the in-loop filter unit 120 may perform RDO for the restoration image in-loop filtered and bit amount information, which is produced like this, and provide result information of the performed RDO with the image prediction unit 100. Then, the image prediction unit 100 may determine an encoding mode which will be applied to image prediction by using the result information, provided from the in-loop filter unit 120, of the performed RDO.

A reference image buffer 122 may temporarily store the restored image in-loop filtered through the in-loop filter unit 120.

Further, the restoration image used for choosing a final encoding mode in FIG. 1 is an image used for input of the in-loop filter unit 120, and it is previously described that there is a problem in that use of the RDO in the previous step of an in-loop filter causes a difference in the restoration image which is finally decoded and necessary bit amount, thereby deteriorating the efficiency of the video encoding.

Therefore, in the present invention, it is possible to increase the efficiency of video encoding by using a restoration image used for choosing a final encoding mode as an image output after in-loop filtering in the in-loop filter unit 120.

Hereinafter, let A be an image input to the in-loop filter unit 120, and let B be an image output from the in-loop filter unit 120.

In the in-loop filter unit 120, in order to reduce an error value occurred through transform or quantization, SAO (Sample Adaptive Offset), ALF (Adaptive Loop Filter) and the like may be used, and a deblocking filter may be used for reducing blocking effects.

At this time, because the information of each filter is required for decoding, additional bit amount is generated through a filtering process in the in-loop filter unit 120. In the description hereinafter, let R1 be a bit amount necessary for reconstructing the A, and let R2 be a bit amount necessary for reconstructing the B. The R2 may be obtained through practical encoding, or a predicted value may be used.

The bit amount which is finally encoded and generated is R2, and the difference from an original image, which is obtained through the B, is a value representing the difference between a finally encoded and generated image and an original image at this time.

Therefore, instead of the restoration image A and necessary bit amount R1 used for the conventional RDO, if the restored image B which has passed through the in-loop filter unit 120 and the necessary bit amount R2 are used, more accurate optimal encoding mode may be obtained as in the present invention, and video encoding efficiency may be increased consequentially. Further, in order to reduce the complexity of the process to obtain the output of the actual in-loop filter unit 120, an encoding mode may be determined by predicting the B and R2 in the same location using prior RDO.

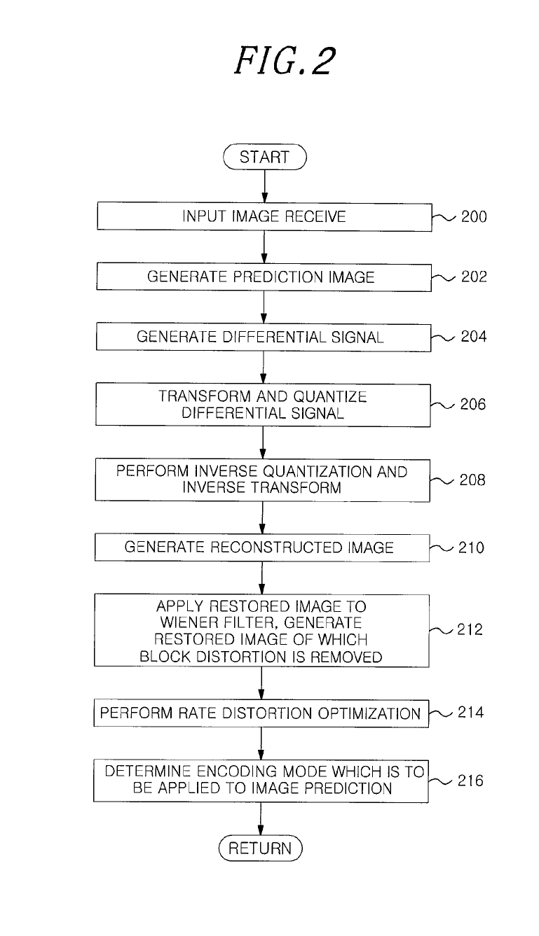

FIG. 2 is a flow chart showing video encoding signal processing in a video encoder using RDO in accordance with an embodiment of the present invention. Hereinafter, referring to FIGS. 1 and 2, embodiments of the present invention will be described in detail.

First, if an input image is received in operation 200, in the image prediction unit 100 within the video encoding apparatus 150, a prediction image about an original input image currently targeted for encoding is generated by using a reference image or an input image in operation 202. At this time, the reference image means an in-loop filtered image outputted from the in-loop filter unit 120.

In view of the above, in case that a prediction image is generated through the image prediction unit 100, by subtracting the prediction image generated by the image prediction unit 100, a differential signal is generated in the differential signal generation unit 108 in operation 204. That is, in case that one image block of an input image is encoded, the image prediction unit 100 may generate a prediction image block about an image block targeted for encoding, and the differential signal generation unit 108 may generate a differential signal about an image block targeted for encoding.

The differential signal generated as described above is input to the transformation unit 110.

Further, the transformation unit 110 may perform transformations such as discrete cosine transform and discrete sine transform on a differential image generated by differentiating an input image and a prediction image to output a transform coefficient.

Further, the quantization unit 112 may perform quantization by quantizing an input transform coefficient according to a quantization parameter and outputting a quantized coefficient in operation 206. Next, the differential signal in which the quantization has been performed as described above may be entropy encoded through the entropy encoding unit 124 and may be output as a bit stream.

Thereafter, a quantization of the signal output from the quantization unit 112 may be performed in the inverse quantization unit 114 within the video encoding apparatus 150 and the inverse transformation unit 116 may perform a discrete cosine transform or a discrete sine transform about a signal output from the inverse quantization unit 114 in operation 208.

As described above, the signal that a discrete cosine transform is performed in the inverse transformation unit 116 is input to the restoration image generation unit 118, and by using the signal output from the inverse transformation unit 116 and prediction image in the restoration image generation unit 118, a restoration image about an original input image may be generated in operation 210.

Next, the in-loop filter unit 120 may reduce differences between the restoration image and the original input image by combining one or at least two components of SAO, ALF or a deblocking filter, and performing filtering actions for the restoration image in operation 212.

Further, in accordance with an embodiment of the present invention, the in-loop filter unit 120 may produce restoration image which is in-loop filtered by in-loop filtering for the restoration image, and by producing bit amount information necessary for restoring a restoration image which is in-loop filtered, the RDO may be performed in operation 214.

The result information of the RDO performed as described above is provided with the image prediction unit 100, and in the image prediction unit 100, encoding mode which is to be applied to image prediction may be determined by using the provided result information of the RDO in operation 216.

Therefore, the present invention may provide that the efficiency of video encoding is increased by using an image outputted after in-loop filtering in the in-loop filter unit 120 as the restoration image used for choosing final encoding mode.

As described above, in accordance with the present invention, it is possible to obtain more accurate encoding mode by using the RDO not in the previous step of the in-loop filter but in the image output from the in-loop filter, and it is possible to improve the efficiency of the video encoding by reducing the bit amount necessary for restoring differences between the restoration image which is finally decoded and the original image. Further, it is possible to improve the efficiency of the video encoding by performing the RDO using the bit amount information and distortion between the image output from the in-loop filter and the original image.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. An apparatus for video encoding, comprising:
an image prediction unit configured to generate a prediction image about an input image which is a target of encoding using a reference image;
a differential signal generation unit configured to generate a differential signal by subtracting the prediction image from the input image generated by the image prediction unit;
a restoration image generation unit configured to generate a first restoration image about the input image using the prediction image; and
an in-loop filter unit configured to produce, by performing an in-loop filtering for the first restoration image, a second restoration image that in-loop filtering has been performed, and after performing rate distortion optimization (RDO) by producing bit amount information necessary for restoring the second restoration image, provide result information of the RDO with the image prediction unit.

2. The apparatus of claim 1, wherein the image prediction unit determines an encoding mode which is applied to the prediction image using the result information of the RDO.

3. The apparatus of claim 1, wherein the bit amount information is information for restoring difference between the input image and the second restoration image.

4. A method for video encoding, comprising:
generating a prediction image about an input image which is an encoding target using a reference image;
generating a differential signal by subtracting the prediction image generated by an image prediction unit from the input image;
generating a first restoration image about the input image using the prediction image;
producing a second restoration image that an in-loop filtering has been performed, by performing in-loop filtering for the first restoration image;
producing bit amount information necessary for restoring the second restoration image;
performing rate distortion optimization (RDO) by using the second restoration image that the in-loop filtering has been performed and the bit amount information;
determining an encoding mode which is applied to image prediction using result information of the RDO.

5. The method of claim 4, wherein the bit amount information is information for restoring difference between the input image and the second restoration image.
